(19) United States
(12) Patent Application Publication
(10) Pub. No.: US 2024/0153368 A1
(43) Pub. Date: May 9, 2024

(54) SYSTEM AND METHOD OF IMPROVING SENSOR RESPONSE FOR A MAGNETIC GATEWAY USING A MAGNETIC BUCKING APPARATUS

(71) Applicant: Xtract One Technologies Inc., Toronto (CA)

(72) Inventors: Elliot Mark HOLTMAN, Vancouver (CA); Nico VAN DEN HOOFF, Vancouver (CA)

(21) Appl. No.: 18/506,108

(22) Filed: Nov. 9, 2023

Related U.S. Application Data
(60) Provisional application No. 63/423,827, filed on Nov. 9, 2022.

(51) Int. Cl. G08B 13/196; G01V 3/10

(52) U.S. Cl. CPC G08B 13/19695; G01V 3/104

(57) ABSTRACT

A system and method of improving sensor response for a magnetic gateway of a threat detection system using a magnetic bucking apparatus. The magnetic bucking apparatus is configured to improve sensor response and saturation issues in the magnetic gateway. A secondary magnetic array is used to neutralize or cancel the strong field produced from a large magnetic array around the sensors of the magnetic gateway.

### CROSS REFERENCE TO RELATED APPLICATIONS

The application claims priority to and the benefit of U.S. Provisional Application Ser. No. 63/423,827, entitled “SYSTEM AND METHOD OF IMPROVING SENSOR RESPONSE FOR A MAGNETIC GATEWAY USING A MAGNETIC BUCKING APPARATUS”, filed on Nov. 9, 2022, the disclosure of which is incorporated herein by reference in its entirety.

### BACKGROUND

The embodiments described herein relate to security and surveillance, in particular, technologies related to threat detection systems.

One of the challenges when using the static magnetic array to help detect objects passing through the gateway is not only does the array magnetize the objects of interest, but it also magnetizes the cores on the receiver sensor induction coils (the cores are chosen because of their high magnetic susceptibility). When the cores become saturated or partially saturated from the field of the primary magnetic array, the response from the coils is considerably reduced to the point of having virtually no measurable signal for the z component coil which is subject to the strongest field (component inline the array direction).

Attempts were made to reduce the field behind the gateway by installing a steel shunt plate to “pull” the field lines into the steel plate and project the field more into the gateway than behind. While this worked somewhat for the x and y directed coils, the z coil was still very saturated and consistently measured virtually no signal even for strongly magnetized objects passing through the gateway. The steel shunt plate is also very heavy making the tower unstable, hard to move and expensive.

Furthermore, not being able to effectively measure the z component response may make the system more susceptible to electromagnetic interference than if we were able to measure all three components of the response from objects passing through the gate. EM waves from far field sources may propagate as plane waves polarized in a particular direction. It is possible that being able to record all three components of the field will allow for more robust and effective noise removal as one component of the object response would couple less to the EMI than if we were only able to record 2 components of the data.

Thirdly having the sensors placed within a strong magnetic field from the primary array can cause issues with respect to vibrations of the magnetic array with respect to the sensors. Since we are measuring time varying changes in the magnetic field (dB/dt), any movement of the primary magnets with respect to the sensors will record a massive response and completely drown out any response from a real object passing through the gate. We currently see many issues in the field from different forms of pillar vibrations.

There is a desire to implement a system and method for improving sensor response in a magnetic gateway.

### SUMMARY

A system and method of improving sensor response for a magnetic gateway of a threat detection system using a magnetic bucking apparatus. The magnetic bucking apparatus is configured to improve sensor response and saturation issues in the magnetic gateway. A secondary magnetic array is used to neutralize or cancel the strong field produced from large magnetic array around the sensors of the magnetic gateway.

### BRIEF DESCRIPTION OF THE DRAWINGS

FIG. 1A is a diagram illustrating an exemplary gateway detection system a magnetic bucking apparatus.

FIG. 1B are graphs illustrating responses from a symmetric steel ball bearing passing through the gateway.

FIG. 1C are graphs illustrating a response from a symmetric steel ball bearing passing through the gateway with bucking magnets.

FIG. 2A is a diagram illustrating grid of magnet positions on A side.

FIG. 2B is a diagram illustrating grid of magnet positions on B side.

FIG. 2C is a diagram illustrating placement of bucking magnet in grid cell A1, with south pole facing up.

FIG. 2D is a diagram illustrating a noise source in action for the experiment.

FIG. 2E is a diagram illustrating a second version of magnet position grid for the experiment.

FIG. 3A is a graph illustrating the noise source with no bucking magnets.

FIGS. 3B and 3C are graphs illustrating noise source with bucked magnets in each grid cell.

FIG. 3D is a diagram illustrating the optimal mounting distance of the magnet for the experiment.

FIG. 4 is a block diagram illustrating a gateway detection system.

FIG. 5 is a hardware and software block diagram illustrating micro-services.

### DETAILED DESCRIPTION

According to Maxwell's equations of electromagnetics, the divergence of B is always equal to zero. It is known that it is not theoretically possible to eliminate the magnetic field from the entire back of the gate (i.e., field lines must return). Furthermore, one does not need to eliminate the field over the entire back volume of the gate; one just wants to be able to reduce or ideally eliminate the field within the vicinity of the coils which is a finite and relatively small volume.

Theoretically, with sufficiently small and numerous discretized magnets, it should be possible to create a secondary magnet array which will locally perfectly cancel the magnetic field from the large primary array around an induction coil. Moreover, one does not need to perfectly cancel the primary field and can likely significantly improve the response characteristics of the induction coils with only a few small discrete “secondary” magnets correctly placed with the appropriate strength and polarity.

According to the disclosure, the basic concept is to use a small secondary magnetic array to neutralize or cancel the strong field produced from the large magnetic array only locally around the sensors. This is a direct magnetic analogy to the concept of bucking coils for loop transmitters, where a second loop with the current flowing in the opposite direction is wound around receivers to cancel the effect of the primary field for the receiver measurements.

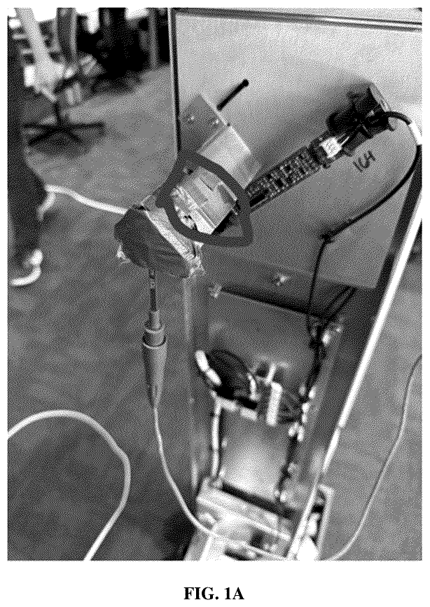

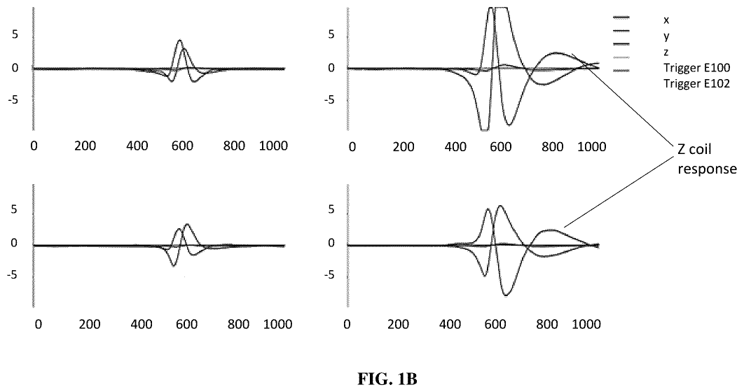

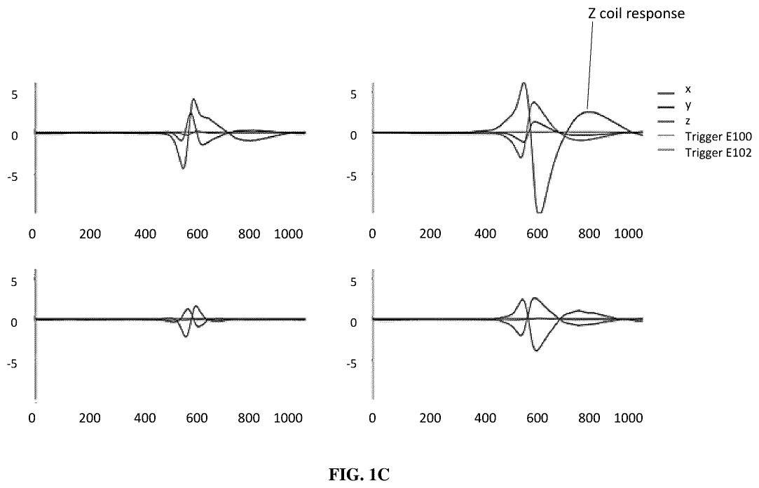

FIG. 1A is a diagram illustrating an exemplary gateway detection system describing a magnetic bucking apparatus. According to FIG. 1A, a small rectangular magnet (highlighted in 1A by a circle) is placed on the side of the z component induction coil. A Gauss meter probe is positioned on the end of the core to help position the magnet (i.e., move the magnet around such that we minimize the response at the probe). Before the secondary magnet is placed next to the coil, the field at the Gauss meter is around 13Mt.

After the magnet is positioned, the field is reduced to virtually zero (around 0-0.5Mt). When the secondary “neutralizing” magnetic is placed next to the coil, the response signal for the core comes back “alive” when watching data off the sensor in real-time. While this is one simple example of partially neutralizing the field reducing the saturation of the core near the sensor, it is likely that the portion of the core closer to the gateway (back metal panel in the photo), is still partially saturated. Furthermore, it is to be understood that to get the best results a custom secondary magnet array should be designed either through simulation or experimentation that properly eliminates the field over all desirable regions.

According to the disclosure, this embodiment is a simple proof of concept demonstration not the optimal solution as it only involves one magnet. A better solution would likely include many magnets positioned in such a way so as to produce the optimal neutralizing field.

FIG. 1B are graphs that illustrate exemplary responses from a symmetric steel ball bearing passing through the gateway. According to FIG. 1B, the current solution the z coil response is virtually non-existent because of coil saturation due to the primary magnet array.

FIG. 1C are graphs illustrating a response from a symmetric steel ball bearing passing through the gateway with bucking magnets. According to FIG. 1C, bucking magnets are placed on the z component coils to at least partially neutralize the primary field from our large magnet array. As can be seen, the z coil response is now much more similar to what we would expect (similar magnitude ranges as the x and y components). While it is likely application dependent, one may expect classification and noise robustness to improve with a system with properly working sensors.

A further experiment was conducted as follows:
1. Obtain two Smart Gateway systems, both hardware version 1.6.8.
2. Leave one system untouched, which is referred to as the “control” system.
3. With the other system, create a method to find an optimal placement of a bucking magnet on each of the four Z-coils on the system. This system is referred to as the “bucked” system. An optimal placement is defined as the one that “revives” the muted signal response of each Z coil, that is, the one that results in the highest Z-coil amplitude response when a ferrous object passes through the gate.
4. Once the “bucked” system is prototyped, collect single object walkthrough data with a steel ball, mimic guns, and two knives. Visualize this data in order to determine how the bucking magnets impact the Z-coil response for each of these items.
5. Collect data with both systems for purposes of machine learning. Train separate “control” and “bucked” machine learning models on these datasets, and compare performance on the test sets.
6. Analyze the performance of each model and conclude on next steps for the experiment, if any.

According to the disclosure, the further experiments utilize two Smart Gateway systems (i.e., hardware version 1.6.8) which were used as part of this experiment. The first system (name 168b) was left unmodified as the control system of the experiment. The second system (name 168_copper_hub_bucked) had a bucking magnet placed near all 4 Z-coils on the system and became the experimental “bucked” system.

In order to find an optimal placement for a bucking magnet near the Z coil, a grid of cells was created on the sensor L-bracket of the system. Each cell was 1.5″ apart, except for the 4th cell, which was slightly smaller due to the length of the bracket that holds the coil. The L bracket had two sides, and each side was divided into the same grid.

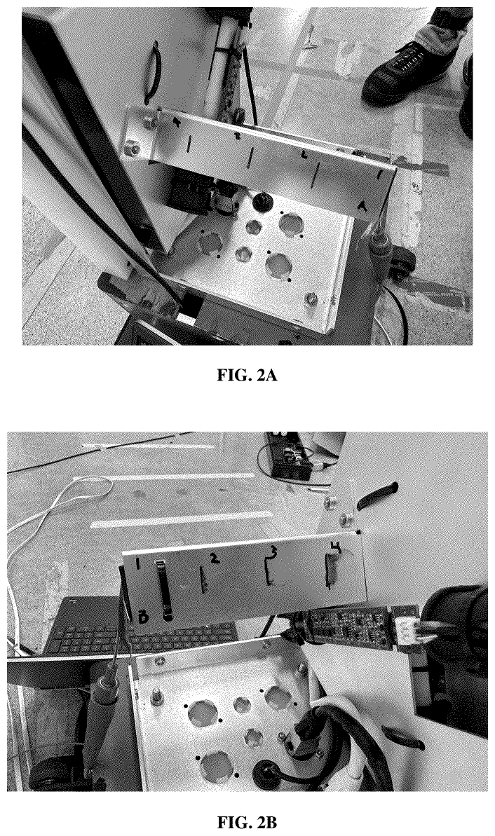

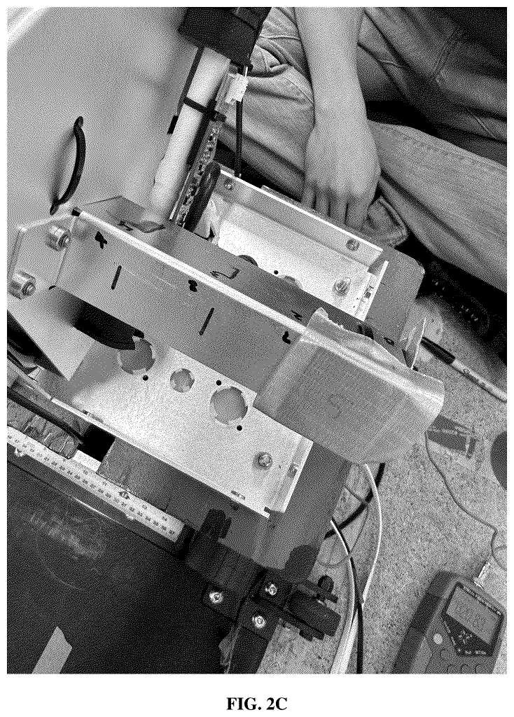

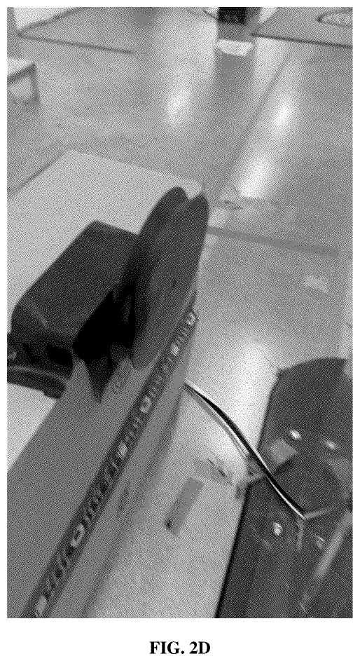

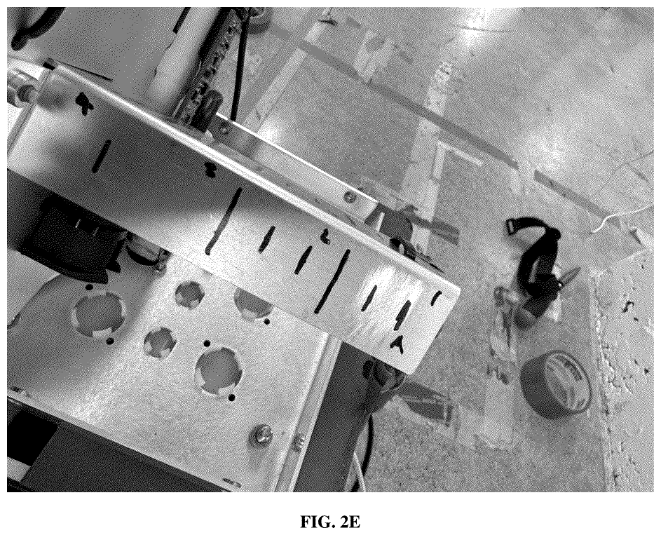

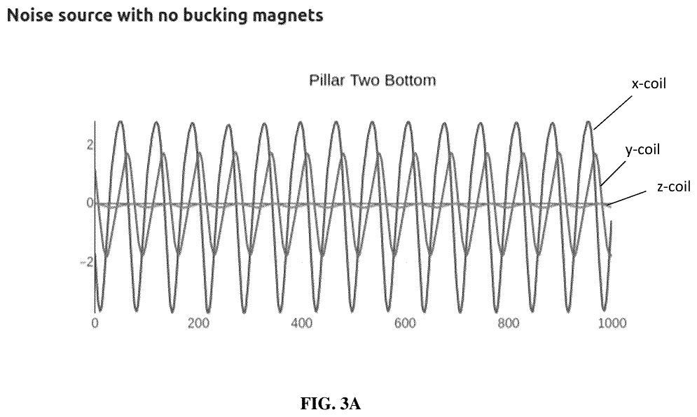

FIGS. 2A and 2B show the grids on sides A and B of the L bracket, named grid cells A1-A4 and B1-B4. FIG. 2A is a diagram illustrating a grid of magnet positions on A side. FIG. 2B is a diagram illustrating a grid of magnet positions on B side.

With the grid established, a 1.5″ square neodymium magnet was placed in a grid cell. FIG. 2C is a diagram illustrating placement of a bucking magnet in grid cell A1, with the south pole of the magnet facing up. As there are 8 grid cells, with two polarities of the bucking magnet, this resulted in 8 cells*2 poles=16 total magnet placements.

Next, a constant noise source was created. More specifically, a DC motor was fitted with a spool and off-concentric magnet (south pole facing the receivers). The motor was then taped to a box 8″ away from the magnet array on the system, and roughly centered with the receiver group of interest. Data was recorded for each of the 16 magnet placements with the noise source, in addition to a 17th recording which included no bucking magnet (i.e. control).

FIG. 2D is a diagram illustrating a noise source in action for the experiment. According to FIG. 2D, a 1 inch square magnet was taped to a motorized spool that spun, effectively providing a constant noise source to the bottom receiver group on the follower pillar.

Once the first 16 recordings were obtained, the signals were visually plotted. From this, it was clear that the most promising grid cell locations were 1 and 2 (on both sides A and B). Therefore, these cells were further subdivided with 2 more segments for a total of 16 more potential placements (now 16 initial+16 new=32 total placements tested). FIG. 2E is a diagram illustrating a second version of magnet position grid for the experiment. FIG. 2E shows the second version of the grid on side A of the L bracket.

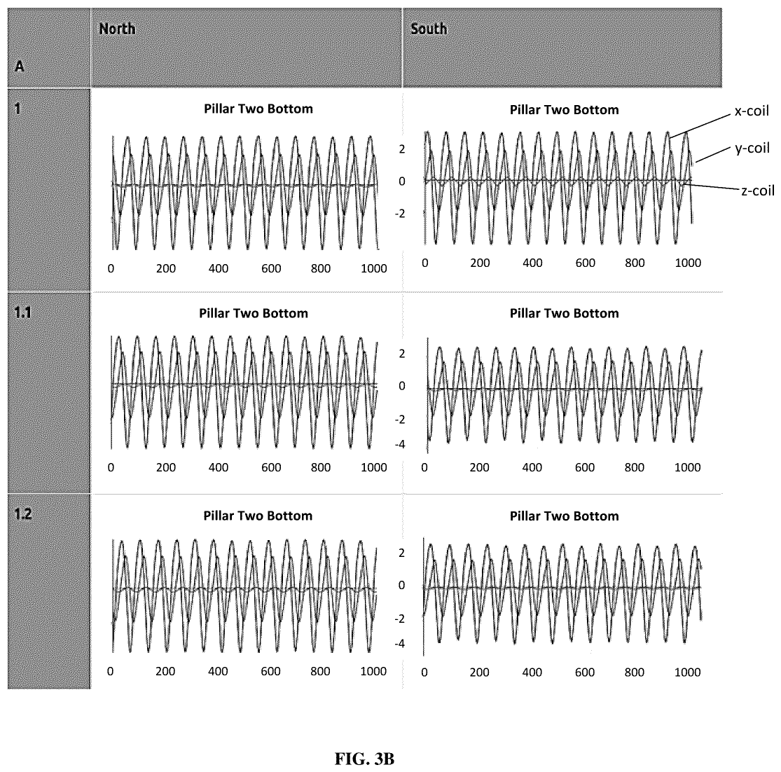

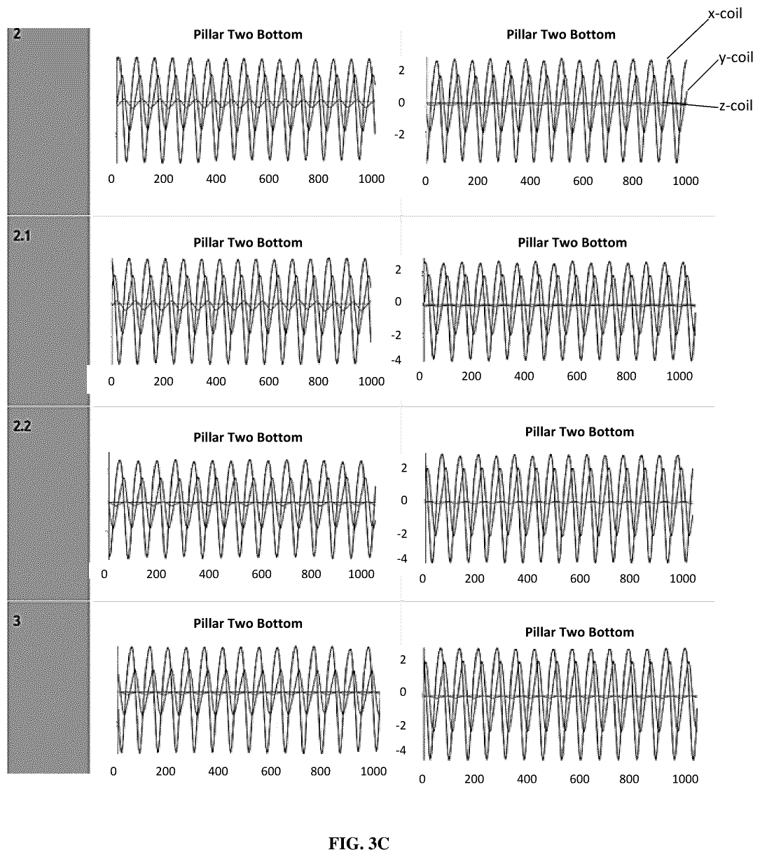

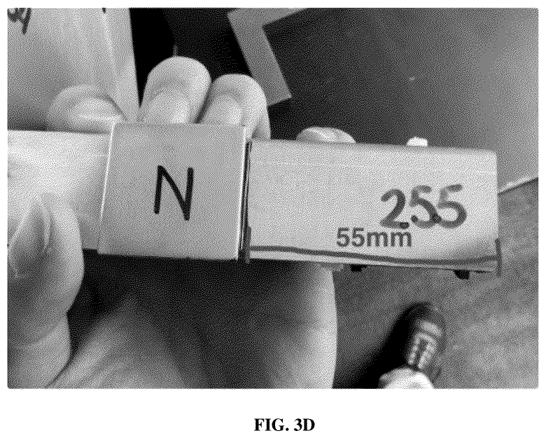

According to the disclosure, data from the experiment was plotted for the x-coil, y-coil and z-coil (coil of reference). FIG. 3A is a graph illustrating the noise source with no bucking magnets. According to FIG. 2A, the z-coil response is minimal. FIGS. 3B and 3C are graphs illustrating noise source with bucked magnets in each grid cell.

According to FIGS. 3A to 3C, the data shows the location that produces the greatest “revived” z-coil response to the constant noise was location 2.2, located roughly 55 mm from the outer edge of the coil mount as shown in FIG. 3D. FIG. 3D is a diagram illustrating the optimal mounting distance of the magnet for the experiment. Note that this optimal mounting distance depends on, among other factors, the geometry and magnetic characteristics of the installation, and may be different for other embodiments.

Once the optimal position for the first magnet was determined, the bucking magnet was secured down. A similar procedure was then performed with a second magnet to see if adding a second bucking magnet could improve the response of the z-coil further. Results of further experiments indicate the second magnet did not meaningfully help revive the z coil response.

According to the disclosure, some conclusions can be drawn from the experiment:
A bucking magnet can and does improve the sensor response on the z coil.
A bucking magnet, when used to improve the sensor response on the z coil, dampens/slightly mutes the responses on the x coil and y coil.
Each coil (x coil, y coil, z coil) appears to contribute to better model performance, as a model trained with all 3 sensors vs 1 or 1 performs the best, on both the bucking and control systems.
A bucking magnet may improve machine learning performance (further testing may be required).

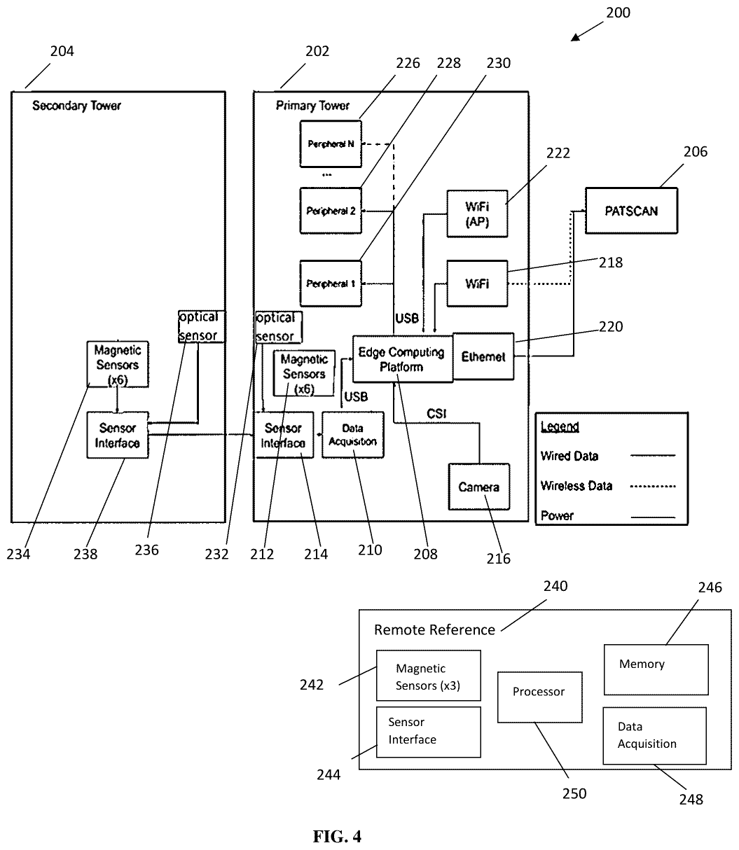

FIG. 4 is a block diagram illustrating a gateway detection system. According to FIG. 4, the gateway detection system 200 consists of a primary tower 202, a secondary tower 204 and a threat detection system such as PATSCAN 206, connected to each other either through a wired or wireless connection. The primary tower 202 consists of the main components of the system including an Edge computing platform 208, data acquisition unit 210, multiple magnetic sensors 212, sensor interfaces 214, one or more cameras 214, a Wi-Fi® module 218 and Ethernet module 220 for connectivity, Wi-Fi® access point 222 and connections to multiple peripherals 226, 228 and 230. The peripherals include optical sensors 232, camera(s), display(s), light(s), speaker(s), accelerometer, Wi-Fi® and Bluetooth units. The secondary tower 204 includes multipole magnetic sensors 234, optical sensor 236 and sensor interface 238 and is connected to the primary tower by a wired data link (e.g., Ethernet). In further embodiments, a wireless connection such as Wi-Fi®, Bluetooth®, IRDA, cellular or other wireless connectivity mediums may be supported.

According to FIG. 4, gateway detection system 200 also consists of a remote reference 240. Remote reference 240 further comprises a 3-axis magnet sensor 242, sensor interface 244, memory 246, data acquisition module 248 and processor 250. Remote reference 240 will communicate wirelessly with primary tower 202 and secondary tower 204.

According to the disclosure, a multi-sensor threat detection system may contain an onboard processor (e.g., Nvidia Jetson) that performs artificial intelligence (AI) to detect the presence of a threat. This removes the need for network dependence on the deployment facility, thereby strongly facilitating the deployment. The onboard processor also reduces the latency of alert, when compared to performing the AI on a server. This results in a smoother screening experience, as the alert latency can handle the high throughput rates. This also removes the reliance on an external server which acted as a single point of failure across all connected systems previously.

The disclosure also contains multiple peripheral components that assist with alerting and control of operations. A camera is used to capture the patron that has alerted and to present evidence to the security guard to help with secondary screening. This assists the security guard in identifying the corresponding threat detection with the patron. Further, the system contains an alert indicator display that indicates an alert and shows the threat location on-body, as well as possibly the image of the alerting patron. There is also an audible signal to indicate an alert.

These peripherals all work to enable the security guard to quickly take decisions on patrons entering the facility with prohibited items in high throughput use cases, such as stadiums or event venues. More information on further embodiments of a multi-sensor gateway is disclosed in U.S. Provisional application Ser. No. 18/093,937, entitled “SYSTEM AND METHOD SMART STAND-ALONE MULTI-SENSOR GATEWAY FOR DETECTION OF PERSON-BORNE THREATS”, filed on Jan. 6, 2023, the disclosure of which is incorporated herein by reference in its entirety.

According to FIG. 4, the system has onboard Wi-Fi®, as well as Ethernet, to connect to a web browser to provide more analytics to the user via a user interface. Furthermore, to enhance the stand-alone capability of the system, wheels are added for better portability. Also, a baseplate is added for better physical stability of the system against vibrations and tipping hazards.

To further help with control of operations, a display is placed on the patron side educating the patrons on how to walk through the system, and what distance to keep from the patron ahead. Furthermore, a backup option is provided for connecting the gateway system over Ethernet to the software platform for control and upgrades of the system algorithms and operations remotely.

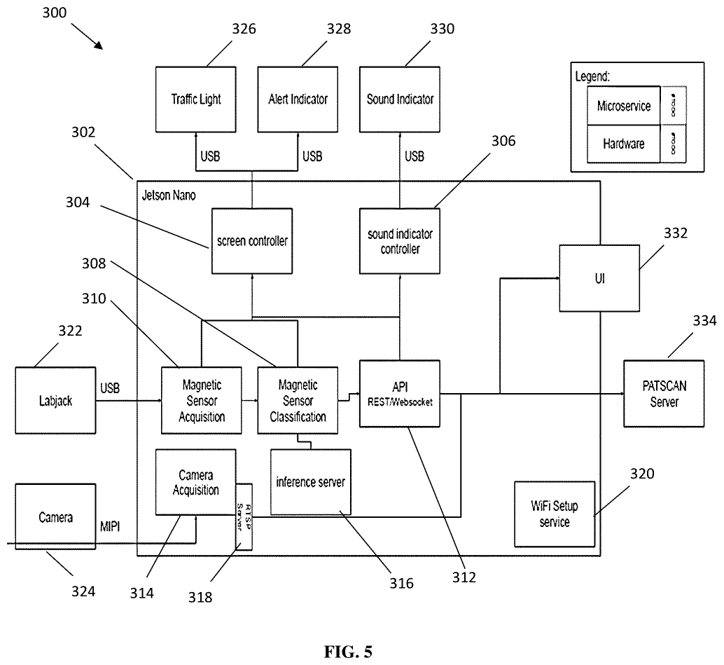

FIG. 5 is a hardware and software block diagram illustrating micro-services. According to FIG. 5, the onboard processor (e.g., Nvidia Jetson) includes such components as screen controller, sound indicator controller, magnetic sensor acquisition module, magnetic sensor classification module, REST/websockets API, camera acquisition module, inference server, RTSP server and a WiFi Setup service. The onboard processor is connected to input and outputs (via USB, Ethernet or wirelessly) including Labjack, cameras, traffic lights, alert indicators, sound indicators. Furthermore, the onboard processor is also connected to a user interface (UI) on a gateway detection system such as a PATSCAN server.

FIG. 5 is a hardware and software block diagram illustrating micro-services. According to FIG. 5, system 300 has an onboard processor 302 (e.g., Nvidia Jetson) including such components as screen controller 304, sound indicator controller 306, magnetic sensor acquisition module 308, magnetic sensor classification module 310, REST/websockets API 312, camera acquisition module 314, inference server 316, RTSP server 318 and a Wi-Fi Setup service 320. The onboard processor is connected to input and outputs (via USB, Ethernet or wirelessly) including Labjack 322, cameras 324, traffic lights 326, alert indicators 328, sound indicators 330. Furthermore, the onboard processor is also connected to a user interface (UI) 332 and a gateway detection system such as a PATSCAN server 334.

According to FIG. 5, the onboard processor (e.g., Nvidia Jetson) utilizes a micro-services architecture. A breakdown of the micro-services architecture is as follows:
Magnetic Sensor Acquisition Service: The classification service takes in data from a LabJack T7 via USB and formats it together for the classifier to use.
Magnetic Sensor Classification Service: The classification service takes in data from acquisition and classifies the data using the inference server. It then sends the results.
Inference Server Service: The Triton Inference Server is used by classification services to perform inference with AI models. Data is sent thru GRPC, and results are returned to the classifier.
Screen Controller Service: Controls the traffic light and alert indicator based on information from acquisition and classifier, as well as user input from the API.
Sound Indicator Controller Service: Controls the speakers based on information from acquisition and classifier, as well as user input from the API.
Camera Acquisition Service: A Deepstream/gstreamer based service that takes in data from a CSI camera and re-transmits it for PATSCAN via RTSP and strips out JPEG frames and saves them to disk.
API Service: A service that provides endpoints for control from the UI.

According to the disclosure, permanent magnets are used to neutralize the response from our primary magnet array in a direct analogy to the known electric bucking solution. In further embodiments, permanent magnets may be replaced with static electric currents to perform the same or similar functionality.

According to the disclosure, a multi-sensor magnetic gateway system with improved sensor response is disclosed. The system comprises a first pillar having a plurality of first sensors, a second pillar having a plurality of second sensors, a stereo camera contained within the first or second pillar, a Wi-Fi® module on the first pillar configured for the pillars to communicate over Wi-Fi®, a platform computer server and processor configured to receive data and process the data, a display screen displaying output data on a user interface (UI) and one or more bucking magnets placed on the first and second pillar wherein the bucking magnet is placed at a distance that improves sensor response by neutralizing the z coil response produced from the magnetic array.

According to the disclosure, the one or more bucking magnets of the system cancels the z coil response. The one or more bucking magnets further dampens the x coil response or the y coil response.

According to the disclosure, the one or more bucking magnets of the system are placed 55 mm from the sensor for improved sensor response. The integration of the one or more bucking magnet with the multi-sensor magnetic gateway system is configured to improve machine learning performance.

According to the disclosure, a computer-implemented method of improved sensor response for a multi-sensor magnetic gateway system is disclosed. The method comprising the steps of providing a computer with a processor, providing a first pillar having a plurality of first sensors, providing a second pillar having a plurality of second sensors, providing a stereo camera on the first or second pillar, providing a Wi-Fi® module on the first pillar configured for the pillars to communicate over Wi-Fi®, providing a display screen displaying a user interface (UI), providing a platform computer server and processor configured to receive data and process the data, providing one or more bucking magnets placed on the first and second pillar wherein the bucking magnet is placed at a distance that improves sensor response by neutralizing the z coil response produced from the magnetic array.

According to the disclosure, the one or more bucking magnets of the method cancels the z coil response. The one or more bucking magnets of the method dampens the x coil response or the y coil response.

According to the disclosure, the one or more bucking magnets of the method are placed 55 mm from the sensor for improved sensor response. The integration of the one or more bucking magnet with the multi-sensor magnetic gateway system of the method is configured to improve machine learning performance.

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. It should be noted that a computer-readable medium may be tangible and non-transitory. As used herein, the term “code” may refer to software, instructions, code or data that is/are executable by a computing device or processor. A “module” can be considered as a processor executing computer-readable code.

A processor as described herein can be a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be a controller, or microcontroller, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, any of the signal processing algorithms described herein may be implemented in analog circuitry. In some embodiments, a processor can be a graphics processing unit (GPU). The parallel processing capabilities of GPUs can reduce the amount of time for training and using neural networks (and other machine learning models) compared to central processing units (CPUs). In some embodiments, a processor can be an ASIC including dedicated machine learning circuitry custom-build for one or both of model training and model inference.

The disclosed or illustrated tasks can be distributed across multiple processors or computing devices of a computer system, including computing devices that are geographically distributed. The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.” While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The system should therefore not be limited by the above-described embodiment, method, and examples, but by all embodiments and methods within the scope and spirit of the system. Thus, the present disclosure is not intended to be limited to the implementations shown herein but is to be accorded the widest scope consistent with the principles and novel features disclosed herein.

What is claimed is:

1. A multi-sensor magnetic gateway system with improved sensor response, the system comprising:
a first pillar having a plurality of first sensors;
a second pillar having a plurality of second sensors;
a stereo camera contained within the first or second pillar;
a Wi-Fi® module on the first pillar configured for the pillars to communicate over Wi-Fi®;
a platform computer server and processor configured to receive data and process the data;
a display screen displaying output data on a user interface (UI); and
one or more bucking magnets placed on the first and second pillar;
wherein the bucking magnet is placed at a distance that improves sensor response by neutralizing the z coil response produced from the magnetic array.

2. The system of claim 1 wherein the one or more bucking magnets cancels the z coil response.

3. The system of claim 1 wherein the one or more bucking magnets dampens the x coil response or the y coil response.

4. The system of claim 1 where the one or more bucking magnets are placed 55 mm from the sensor for improved sensor response.

5. The system of claim 1 wherein the integration of the one or more bucking magnet with the multi-sensor magnetic gateway system is configured to improve machine learning performance.

6. A computer-implemented method of improved sensor response for a multi-sensor magnetic gateway system, the method comprising the steps of:
Providing a computer with a processor;
providing a first pillar having a plurality of first sensors;
providing a second pillar having a plurality of second sensors;
providing a stereo camera on the first or second pillar;
providing a Wi-Fi® module on the first pillar configured for the pillars to communicate over Wi-Fi®;
providing a display screen displaying a user interface (UI);
providing a platform computer server and processor configured to receive data and process the data;
providing one or more bucking magnets placed on the first and second pillar;
wherein the bucking magnet is placed at a distance that improves sensor response by neutralizing the z coil response produced from the magnetic array.

7. The method of claim 6 wherein the one or more bucking magnets cancels the z coil response.

8. The method of claim 6 wherein the one or more bucking magnets dampens the x coil response or the y coil response.

9. The method of claim 6 where the one or more bucking magnets are placed 55 mm from the sensor for improved sensor response.

10. The method of claim 6 wherein the integration of the one or more bucking magnet with the multi-sensor magnetic gateway system is configured to improve machine learning performance.
